(19) United States
(12) Patent Application Publication
(10) Pub. No.: US 2026/0045415 A1
(43) Pub. Date: Feb. 12, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Myungwoo Lee, Suwon-si (KR); Jinseong Kim, Suwon-si (KR); Yongju Yoo, Suwon-si (KR)

(73) Assignee: SAMSUNG ELECTRO-MECHANICS CO., LTD., Suwon-si (KR)

(21) Appl. No.: 19/013,648

(22) Filed: Jan. 8, 2025

(30) Foreign Application Priority Data
Aug. 8, 2024 (KR) 10-2024-0106261

(51) Int. Cl. H01G 4/12; H01G 4/30

(52) U.S. Cl. CPC H01G 4/1227; H01G 4/30

(57) ABSTRACT

A multilayer ceramic capacitor and a method of manufacturing the multilayer ceramic capacitor, which includes a capacitor body including a dielectric layer and an internal electrode layer, and an external electrode disposed on the outside of the capacitor body, wherein the dielectric layer includes a plurality of dielectric grains, and at least one of the plurality of dielectric grains comprises a black dot, the black dot is included in the number of 4 to 16 per 1 μm×1 μm cross-sectional area within the dielectric layer, and the black dot includes Si element and does not include at least two elements selected from Ba, Ti, and O.

### CROSS-REFERENCE TO RELATED APPLICATION

This application claims priority to and the benefit of Korean Patent Application No. 10-2024-0106261 filed in the Korean Intellectual Property Office on Aug. 8, 2024, the entire contents of which are incorporated herein by reference.

### BACKGROUND

### (a) Technical Field

The present disclosure relates to a multilayer ceramic capacitor and a manufacturing method thereof.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Meanwhile, as barium titanate, a piezoelectric material and photoelectric material, is recently being used as the main material for MLCCs, research is being conducted to improve reliability.

### SUMMARY

An embodiment provides a multilayer ceramic capacitor having excellent reliability and withstand voltage characteristics.

Another embodiment provides a method of manufacturing a multilayer ceramic capacitor.

An embodiment provides a multilayer ceramic capacitor includes a multilayer ceramic capacitor including a capacitor body including a dielectric layer and an internal electrode layer, and an external electrode disposed on an outside of the capacitor body, wherein the dielectric layer includes a plurality of dielectric grains, and at least one of the plurality of dielectric grains comprises at least one black dot, the dielectric layer includes 4 to 16 of the at least one black dot per 1 μm×1 μm cross-sectional area within the dielectric layer, and the at least one black dot includes Si element and is free of at least two elements selected from Ba, Ti, and O.

A size of the at least one black dot measured on a straight line drawn along a major axis of the dielectric grains may be from about 5 nm to about 40 nm.

The dielectric layer may further include a black dot peripheral region defined as a region extending (i) from the at least one black dot to a distance corresponding to 10% to 100% of a size of the at least one black dot, and (ii) in an outer direction of the at least one black dot.

The black dot peripheral region may have a shape surrounding the at least one black dot.

The black dot peripheral region may include a Si element, a Ba element, and a Ti element.

The dielectric layer may include a barium titanate-based main component including Ba and Ti, and a subcomponent including Si.

The Si element included in the at least one black dot and the Si element included in the black dot peripheral region may be at a molar ratio that is in a range of about 1:8 to about 8:1 based on 100 parts by mole of the barium titanate-based main component.

The subcomponent may further include one or more selected from Dy, Tb, Mn, V, Ba, Al, Ca, and Sn.

The subcomponent may include Dy, Tb, Mn, V, Ba, Al, Ca, and Sn.

The at least one of the plurality of dielectric grains may include one black dot.

The at least one black dot may be free of Ba, Ti, and O.

Another embodiment provides a method of manufacturing a multilayer ceramic capacitor including: mixing a barium titanate-based main component powder and a subcomponent powder to prepare a dielectric slurry; manufacturing a dielectric green sheet using the dielectric slurry and forming a conductive paste layer on a surface of the dielectric green sheet; manufacturing a dielectric green sheet stack by stacking a plurality of the dielectric green sheet on which the conductive paste layer is formed; manufacturing a capacitor body including a dielectric layer and an internal electrode layer by firing the dielectric green sheet stack; and forming an external electrode on a surface of the capacitor body, wherein the dielectric layer includes a plurality of dielectric grains, and at least one of the plurality of dielectric grains comprises at least one black dot, the dielectric layer includes 4 to 16 black dots per 1 μm×1 μm cross-sectional area within the dielectric layer, and the black dot includes Si element and does not include at least two elements selected from Ba, Ti, and O.

The above barium titanate-based main component powder may be manufactured by a hydrothermal synthesis method including mixing a barium raw material and a titanium raw material to prepare a barium titanate seed; and grain-growing the barium titanate seed.

The barium raw material and the titanium raw material may be mixed so that a Ba/Ti molar ratio is about 1.020 to about 1.050.

The grain-growing may be performed at a temperature of about 208° C. to about 242° C.

The subcomponent powder may include a Si-containing compound.

The Si-containing compound may be included in an amount of powder about 0.5 parts by mole to about 4 parts by mole based on 100 parts by mole of the barium titanate-based main component powder.

The subcomponent powder may further include at least one selected from a Dy-containing compound, a Tb-containing compound, a Mn-containing compound, a V-containing compound, a Ba-containing compound, an Al-containing compound, a Ca-containing compound, and a Sn-containing compound.

A multilayer ceramic capacitor according to an embodiment can improve not only the withstand voltage characteristics but also the high-temperature stress reliability and moisture resistance reliability by including a dielectric layer with a controlled level of defects in the material.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure of the internal electrode layers in the capacitor body of FIG. 1.

FIG. 5 is a schematic view showing a cross-section of a dielectric layer according to an embodiment.

FIG. 6 is a TEM (transmission electron microscope) image of a dielectric layer according to Example 1.

FIG. 7 is a TEM (transmission electron microscope) image of a dielectric layer according to Comparative Example 1.

FIGS. 8A to 8E are TEM-EDS (Transmission Electron Microscope-Energy Dispersive Spectroscopy) analysis images of a dielectric layer according to Example 1.

FIGS. 9A to 9E are TEM-EDS (Transmission Electron Microscope-Energy Dispersive Spectroscopy) analysis images of a dielectric layer according to Example 2.

FIGS. 10A to 10E are TEM-EDS (Transmission Electron Microscope-Energy Dispersive Spectroscopy) analysis images of a dielectric layer according to Example 3.

FIGS. 11A to 11E are TEM-EDS (Transmission Electron Microscope-Energy Dispersive Spectroscopy) analysis images of a dielectric layer according to Example 4.

FIGS. 12A to 12B are TEM-EDS (Transmission Electron Microscope-Energy Dispersive Spectroscopy) analysis images of a dielectric layer according to Comparative Example 1.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

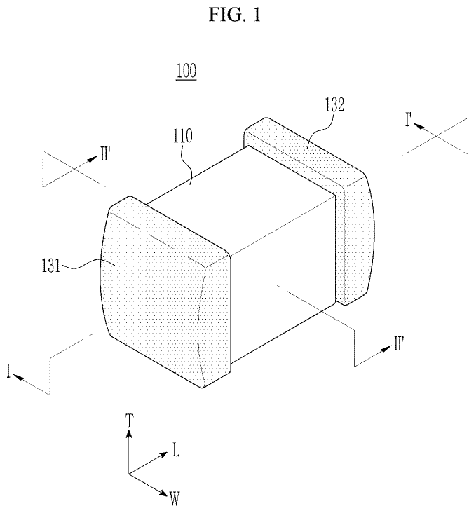

Hereinafter, a multilayer ceramic capacitor according to an embodiment will be described with reference to FIGS. 1 to 4.

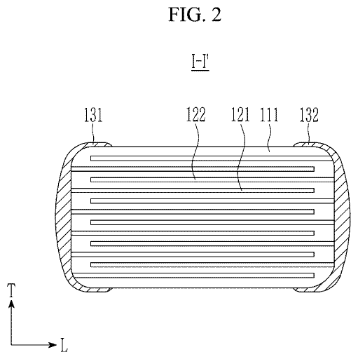

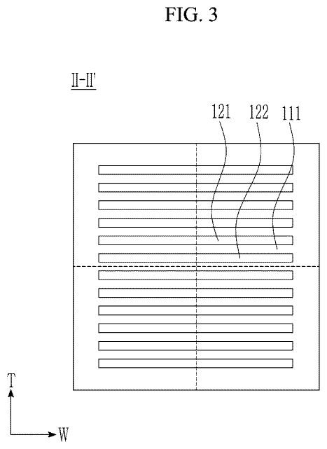

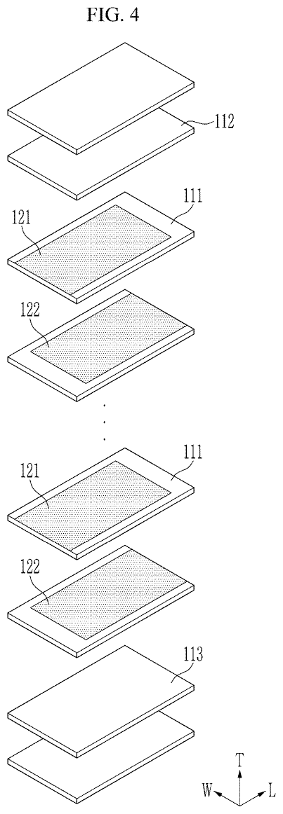

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure of the internal electrode layers in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed outside the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately disposed, which contributes to forming capacitance of the multilayer ceramic capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be positioned on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be located on opposite side ends of the active region in the width direction (W-axis direction), that is, on the fifth surface and the sixth surface, respectively. The side margin region may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin area serve to prevent damage to the first internal electrode layer 121 and the second internal electrode layer 122 due to physical or chemical stress.

Hereinafter, each of the dielectric layer, internal electrode layer, and external electrode is described in detail.

### Dielectric Layer

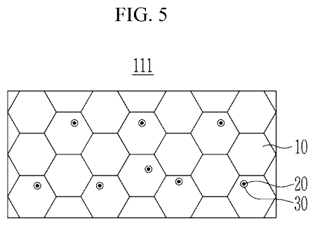

The dielectric layer is explained with reference to FIG. 5.

FIG. 5 is a schematic view showing a cross-section of a dielectric layer according to an embodiment.

Referring to FIG. 5, the dielectric layer 111 includes a plurality of dielectric grains 10, and at least one of the plurality of dielectric grains 10 includes black dots 20.

The black dots 20 according to an embodiment includes a silicon (Si) element and may not include at least two elements selected from barium (Ba), titanium (Ti), and oxygen (O). As the dielectric grains 10 in the dielectric layer 111 have black dots 20 of the above composition, the reliability and withstand voltage characteristics of the multilayer ceramic capacitor can be improved.

The black dots 20 may appear as defects within the dielectric grains 10. However, since black dots 20 include Si elements, they are distinct from defects, pores, or voids that may generally appear in dielectric materials. That is, since the defects, pores, or voids do not include any components and are empty, they can be distinguished from black dots 20 according to an embodiment.

The components forming the black dots 20 can be derived from the barium titanate-based main component and subcomponent forming the dielectric layer 111. For example, the Si element included in the black dots 20 may be derived from a subcomponent including Si. The black dots 20 do not include both elements of barium (Ba) and titanium (Ti) included in the surrounding dielectric layer 111, but rather includes only one of the two elements or neither of the two elements, and thus they can be distinguished from the surrounding within the dielectric layer 111.

The black dots 20 may be included in an amount of 4 to 16, for example, 5 to 15, 6 to 14, or 7 to 13 per 1 μm×1 μm cross-sectional area within the dielectric layer 111. When the dielectric layer 111 includes black dots 20 within the above range, the reliability and withstand voltage characteristics of the multilayer ceramic capacitor can be improved. Specifically, if there are no black dots 20 within the dielectric grains 10, a uniform reaction does not occur for material diffusion, making it difficult to obtain dielectric grains 10 of a uniform size within the dielectric layer 111, and if there are too many black dots 20, a partial discharge breakdown mode may occur due to electric field concentration on the black dots at high temperatures.

The number of black dots 20 having the aforementioned composition within the dielectric layer 111 can be confirmed by TEM-EDS (transmission electron microscope-energy dispersive spectroscopy) analysis of the dielectric layer.

In more detail, after the multilayer ceramic capacitor 100 was placed into the epoxy mixture liquid and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. Next, the active area of the cross-sectional sample can be measured using a transmission electron microscope (TEM) so that at least one layer of the dielectric layer 111, for example, one to five layers, are visible. For example, TEM can be measured under conditions of an acceleration voltage of 200 kV using a Xe-FIB (focused ion beam) in an area of about 2.5 μm×2.5 μm in which at least one dielectric layer 111 is visible in the active area. The number of black dots 20 within the dielectric layer 111 can be confirmed in the TEM image of the measured cross-sectional sample. Next, EDS (energy dispersive spectroscopy) analysis is performed on the TEM image of the measured cross-sectional sample to confirm the components included in the black dots 20 within the dielectric layer 111. Other methods and/or tools appreciated by one of ordinary skill in the art, even if not described in the present disclosure, may also be used.

The size of the black dots 20 may be about 5 nm to about 40 nm, for example, about 7 nm to about 38 nm, about 10 nm to about 35 nm, about 12 nm to about 33 nm, or about 15 nm to about 30 nm. The size of the black dot 20 represents the diameter measured on a straight line drawn based on the long axis of the dielectric grains 10. When the size of the black dot is within the above range, a multilayer ceramic capacitor having excellent reliability and withstand voltage characteristics can be secured.

The size of the above black dots 20 can be confirmed in the TEM image of the cross-sectional sample measured by the above-described method. Other methods and/or tools appreciated by one of ordinary skill in the art, even if not described in the present disclosure, may also be used.

The dielectric layer 111 may further include a black dot peripheral region 30. The black dot peripheral region 30 can be defined as a region from a black dot 20 to a distance corresponding to 10% to 100% of the size of the black dot 20 in an outer direction of the black dot 20. For example, the black dot peripheral region 30 may be in a form that surrounds the black dots 20.

The black dot peripheral region 30 may include a Si element, a Ba element, and a Ti element. The Si, Ba and Ti can all be derived from the barium titanate-based main component and subcomponent forming the dielectric layer 111. Since the black dot peripheral region 30 has a different composition from the black dots 20, the black dots 20 can be distinguished from its surroundings within the dielectric layer 111.

The composition of the black dot peripheral region 30 can be confirmed by TEM-EDS (transmission electron microscopy-energy dispersive spectroscopy) analysis of the dielectric layer, measured by the method described above. Other methods and/or tools appreciated by one of ordinary skill in the art, even if not described in the present disclosure, may also be used.

The dielectric layer 111 may include a barium titanate-based main component and subcomponent.

The barium titanate-based main component is a dielectric matrix, has a high dielectric constant, and contributes to forming the dielectric constant of a multilayer ceramic capacitor 100.

The barium titanate-based main component powder is a compound containing barium (Ba) and titanium (Ti), and may include, for example, BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

The subcomponent may include silicon (Si). In addition, the subcomponents may further include one or more selected from dysprosium (Dy), terbium (Tb), manganese (Mn), vanadium (V), barium (Ba), aluminum (AI), calcium (Ca), and tin (Sn).

According to an embodiment, the Si element included in the black dots 20 and the Si element included in the black dot peripheral region 30 may have a molar ratio of about 1:8 to about 8:1 and for example, a molar ratio of about 1:7 to about 7:1, about 1:6 to about 6:1, about 1:5 to about 5:1, or about 1:4 to about 4:1 based on 100 parts by mole of the barium titanate-based main component. When the molar ratio of Si elements included in each black dot 20 and the black dot peripheral region 30 is within the above range, the reliability and withstand voltage characteristics of the multilayer ceramic capacitor can be improved.

This molar ratio can be confirmed by TEM-EDS (transmission electron microscopy-energy dispersive spectroscopy) analysis of the dielectric layer, measured by the method described above. Other methods and/or tools appreciated by one of ordinary skill in the art, even if not described in the present disclosure, may also be used.

An average thickness (average length in the T-axis direction) of the dielectric layer 111 may be about 2.0 μm to about 8.0 μm, and for example, may be about 0.1 μm to about 6.0 μm. When the average thickness of the dielectric layer 111 is within the above range, the reliability of the multilayer ceramic capacitor may be improved.

The average thickness of the dielectric layer 111 may be measured by placing the multilayer ceramic capacitor 100 in an epoxy mixing solution, curing it, polishing it, and then ion milling it, and then analyzing it using a scanning electron microscope (SEM). A scanning electron microscope can be used, for example, using a Verios G4 product from Thermofisher Scientific, with measurement conditions of 10 kV and 0.2 nA, an analysis magnification of 100 times, and may be measured for at least 1 layer, 3 layers, 5 layers, or 10 layers or more of dielectric layers 111. This may be an arithmetic mean value obtained by taking the central point of the length direction (L-axis direction) or width direction (W-axis direction) of the dielectric layer 111 as a reference point in a scanning electron microscope (SEM) image of a cross-sectional sample measured as described above, and taking the arithmetic mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted.

### Internal Electrode Layer

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The first internal electrode layer 121 and the second internal electrode layer 122 include a conductive metal, and may include, for example, a metal such as Ni, Cu, Ag, Pd, Au, or an alloy thereof, for example, an Ag—Pd alloy.

Additionally, the first internal electrode layer 121 and the second internal electrode layer 122 may include dielectric particles having the same composition as the ceramic material included in the dielectric layer 111.

The first internal electrode layer 121 and the second internal electrode layer 122 may be formed using a conductive paste including a conductive metal. The printing method for the conductive paste may be either screen printing or gravure printing.

Each average thickness of the first internal electrode layer 121 and the second internal electrode layer 122 may be about 0.1 μm to about 2 μm. The average thickness of the first internal electrode layer 121 and the second internal electrode layer 122 may be measured by scanning electron microscope (SEM) analysis. Here, the scanning electron microscope (SEM) analysis is the same as the method used to measure the average thickness of the dielectric layer 111 described above, so its description is omitted.

The capacitor body 110 may be formed by firing a stacking structure in which the plurality of dielectric layers 111 and internal electrode layers 121 and 122 are stacked.

### External Electrode

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

Each of the first external electrode 131 and the second external electrode 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include copper (Cu), nickel (Ni), silver (Ag), palladium (Pd), gold (Au), platinum (Pt), tin (Sn), tungsten (W), titanium (Ti), lead (Pb), an alloy thereof, or a combination thereof, and for example, the term copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from zinc (Zn), titanium (Ti), copper (Cu), vanadium (V), manganese (Mn), iron (Fe) and nickel (Ni), the alkali metal may be selected from lithium (Li), sodium (Na) and potassium (K), and the alkaline-earth metal may be at least one selected from magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the first internal electrode layer 121 and the second internal electrode layer 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. Flake shape powder refers to a powder with a flat and elongated shape, and is not particularly limited. But for example, the length ratio of the major axis and the minor axis (major axis/minor axis) may be greater than or equal to about 1.95.

The first external electrode 131 and the second external electrode 132 may further include the plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer ceramic capacitor 100.

### Method of Manufacturing Multilayer Ceramic Capacitor

Hereinafter, a method of manufacturing the multilayer ceramic capacitor 100 according to an embodiment will be described.

A multilayer ceramic capacitor 100 according to an embodiment may be manufactured by mixing barium titanate-based main component powder and subcomponent powder to prepare a dielectric slurry; manufacturing a dielectric green sheet using the dielectric slurry and forming a conductive paste layer on the surface of the dielectric green sheet; manufacturing a dielectric green sheet stack by stacking the dielectric green sheet in which the conductive paste layer is formed; manufacturing a capacitor body including a dielectric layer and an internal electrode layer by firing the dielectric green sheet stack; and forming an external electrode on a surface of the capacitor body.

The barium titanate-based main component powder is a compound containing barium (Ba) and titanium (Ti), and may include, for example, BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

The barium titanate-based main component powder may be prepared by a hydrothermal synthesis method. Specifically, the barium titanate-based main component powder can be manufactured through manufacturing a barium titanate seed by mixing a barium raw material and a titanium raw material; and grain-growing the barium titanate seed into particles.

The barium source may include barium hydroxide, for example, barium hydroxide octahydrate (Ba(OH)₂·8H₂O) may be used. The barium raw material may be ionized and used by heating it to 60° C. or higher.

The titanium raw material may include a sol of titanium dioxide (TiO_{x/2}(OH)₄₋ₓ) or titanium oxide (TiO₂). The titanium raw material may be used as a sol dispersed in an acid or base.

The barium raw material and the titanium raw material may be mixed so that the Ba/Ti molar ratio is about 1.020 to about 1.050, for example, about 1.022 to about 1.048, or about 1.024 to about 1.046. When barium raw material and titanium raw material are mixed in the above ratio, black dots 20 in the dielectric layer 111 may be obtained in an appropriate range of numbers, and accordingly, a multilayer ceramic capacitor with excellent reliability and withstand voltage characteristics may be secured.

To speed up the production of the barium titanate seed, rapid stirring or microwave or ultrasound may be used.

Next, before the grain-growing the barium titanate seed, the manufactured barium titanate seed may be mixed with pure water and a grain-growth inhibitor.

The grain-growth inhibitor can be used to slow grain-growth of the particles, and may include a material that can lower the polarity of the solvent, for example an alcohol such as butylene glycol, dimethoxyethane, hexanediol, hexyleneglycol, and methoxyethanol; a material that can lower the pH, such as acids such as acetic acid and nitric acid; or a material that can inhibit reprecipitation, for example a surfactant such as sodium alkylsulfate, alkylbenzene sulfonate, N-acrylamino acid salt, acrylamide, diethanol amine, and amine oxide.

Next, the grain-growing may be performed at a high temperature, specifically at a temperature of about 208° C. to about 242° C., for example, at a temperature of about 209° C. to about 241° C., or about 210° C. to about 240° C. When the deposition process is performed within the above temperature range, a suitable number of black dots 20 may be obtained in an appropriate range of numbers, and accordingly, a multilayer ceramic capacitor with excellent reliability and withstand voltage characteristics may be secured.

The grain-growing may be performed for about 1 hour to about 72 hours, for example, for about 3 to about 70 hours.

Next, the grown material may be dried to manufacture a barium titanate main component powder.

The subcomponent powder may include a Si-containing compound.

The Si-containing compound may be included in an amount of about 0.5 parts by mole to about 4 parts by mole, for example about 0.7 parts by mole to about 3.8 parts by mole, about 0.9 parts by mole to about 3.6 parts by mole, about 1.1 parts by mole to about 3.4 parts by mole, about 1.3 parts by mole to about 3.2 parts by mole, or about 1.5 parts by mole to about 3.0 parts by mole barium based on 100 parts by mole of the titanate-based main component powder. When the Si-containing compound is included in the above content range, a suitable number of black dots 20 in the dielectric layer 111 may be obtained in an appropriate range of numbers, and accordingly, a multilayer ceramic capacitor with excellent reliability and withstand voltage characteristics may be secured.

The subcomponent powder may further include one or more additional components selected from a Dy-containing compound, a Tb-containing compound, a Mn-containing compound, a V-containing compound, a Ba-containing compound, an Al-containing compound, a Ca-containing compound, and a Sn-containing compound.

The Dy-containing compound may be included in an amount of about 0.1 parts by mole to about 1 part by mole, for example 0.2 parts by mole to 0.9 parts by mole, or 0.3 to 0.8 parts by mole based on 100 parts by mole of the titanate-based main component powder. The Tb-containing compound may be included in an amount of 0.1 parts by mole to 1 part by mole, for example 0.2 parts by mole to 0.9 parts by mole, or 0.3 to 0.8 parts by mole based on 100 parts by mole of the titanate-based main component powder. The Mn-containing compound may be included in an amount of less than or equal to about 0.2 parts by mole, for example about 0.01 parts by mole to about 0.2 parts by mole, or about 0.05 parts by mole to about 0.15 parts by mole based on 100 parts by mole of the titanate-based main component powder. The V-containing compound may be included in an amount of less than or equal to about 0.15 parts by mole, for example about 0.01 parts by mole to about 0.15 parts by mole, or about 0.05 parts by mole to about 0.1 parts by mole based on 100 parts by mole of the titanate-based main component powder. The Ba-containing compound may be included in an amount of less than or equal to about 2 parts by mole, for example about 0.1 parts by mole to about 2 parts by mole, or about 0.5 parts by mole to about 1.5 parts by mole based on 100 parts by mole of the titanate-based main component powder. The Al-containing compound may be included in an amount of about 0.4 parts by mole to about 0.6 parts by mole, for example about 0.45 parts by mole to about 0.55 parts by mole based on 100 parts by mole of the titanate-based main component powder. The Ca-containing compound may be included in an amount of less than or equal to about 0.8 parts by mole, for example about 0.1 parts by mole to about 0.8 parts by mole, or about 0.3 parts by mole to about 0.6 parts by mole based on 100 parts by mole of the titanate-based main component powder. The Sn-containing compound may be included in an amount of about 0.1 parts by mole to about 5 parts by mole, for example about 0.5 parts by mole to about 4.5 parts by mole, or about 1 part by mole to about 4 parts by mole based on 100 parts by mole of the titanate-based main component powder. When the above additional components are included in the above content range, the reliability and withstand voltage characteristics of the multilayer ceramic capacitor may be improved.

The subcomponent powders, i.e., Si-containing compounds, Dy-containing compounds, Tb-containing compounds, Mn-containing compounds, V-containing compounds, Ba-containing compounds, Al-containing compounds, Ca-containing compounds and Sn-containing compounds, may each be oxides, nitrides or salt compounds, or may be used in the form of a sol dispersed in an organic solvent.

The dielectric slurry may be prepared by additionally mixing additives such as a dispersant, a binder, a plasticizer, a lubricant, an antistatic agent, and a solvent.

The dispersant may include, for example, a phosphoric acid ester-based dispersant, a polycarboxylic acid-based dispersant, or a combination thereof. The dispersant may be mixed in an amount of about 0.1 part by weight to about 5 parts by weight, for example, about 0.3 parts by weight to about 3 parts by weight based on 100 parts by weight of the barium titanate-based main component powder. When the dispersant is mixed within the above content range, the dispersibility of the dielectric slurry is excellent, and the amount of impurities included in the manufactured dielectric layer can be reduced.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based main component powder. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based main component powder. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering dissolubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based main component powder. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

To form a conductive paste layer that becomes an internal electrode layer after firing, a conductive paste may be prepared by mixing a conductive powder made of a conductive metal or an alloy thereof, a binder, and a solvent. Additionally, a barium titanate powder may be mixed in as a co-material if necessary. The co-material may act to suppress sintering of the conductive powder during the firing process. The conductive paste layer is formed by applying a conductive paste to the surface of the dielectric green sheet in a predetermined pattern using various printing methods such as screen printing or transfer methods.

The conductive powder may include nickel (Ni) or a nickel (Ni) alloy. Next, a dielectric green sheet stack is prepared by stacking a plurality of layers of dielectric green sheets on which internal electrode patterns are formed, and then pressing the plurality of layers of dielectric green sheets in the stacking direction. At this time, the dielectric green sheet and the internal electrode layer pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be prepared after binder removal treatment (calcination) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., and may be performed at a temperature of about 1200° C. to about 1350° C. Additionally, the firing may be performed for about 0.5 to about 8 hours, for example, about 1 to about 3 hours. Additionally, the firing may be performed in a reducing atmosphere, for example, in a humidified mixed gas of nitrogen and hydrogen, and may be performed under conditions such as a hydrogen concentration of less than or equal to about 1.0%. When the internal electrode layer includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa. In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer is formed on the outside of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Examples 1 to 7 and Comparative Examples 1 to 6

Barium hydroxide octahydrate (Ba(OH)₂·8H₂O) was mixed with titanium oxide (TiO₂) sol heated to 60° C. or higher to prepare barium titanate seeds. Herein, Ba(OH)₂8H₂O and TiO₂ sol were mixed in a Ba/Ti molar ratio shown in Table 1. Subsequently, the barium titanate seeds were grown at a temperature shown in Table 1 and dried to prepare barium titanate (BaTiO₃) main component powder.

The prepared BaTiO₃ main component powder was mixed with subcomponent powder such as 2.5 parts by mole of SiO₂, 0.5 parts by mole of Dy₂O₃, 0.5 parts by mole of Tb₂O₃, 0.1 parts by mole of MnO₂, 0.08 parts by mole of V₂O₅, 1 part by mole of BaCO₃, 0.5 parts by mole of Al₂O₃, 0.4 parts by mole of CaCO₃, and 2.5 parts by mole of SnO₂ based on 100 parts by mole of the BaTiO₃ main component powder to prepare dielectric slurry.

In the preparation of the dielectric slurry, mixing was performed by using zirconia balls (ZrO₂ balls) as a dispersion medium, adding ethanol/toluene and polyvinyl butyral (PVB) resin as a wetting dispersant and binder, and then mechanically milling.

The dielectric slurry was used by using a head discharge type on-roll forming coater to manufacture a dielectric green sheet.

A conductive paste layer including nickel (Ni) was printed on the surface of a dielectric green sheet, and the dielectric green sheets on which the conductive paste layers were formed were stacked and pressed to manufacture a dielectric green sheet stack.

The dielectric green sheet stack was calcined under the conditions of a calcination temperature of 1300° C. or lower and a hydrogen concentration of 1.0% H₂ or lower through a calcinating process under a nitrogen atmosphere at 400° C. or lower.

Subsequently, the dielectric green sheet stack was used to manufacture a multilayer ceramic capacitor through processes of an external electrode, plating, or the like.

TABLE 1

| | Ba/Ti molar | Grain-growth temperature |
|---|---|---|
| | ratio | (° C.) |
| Example 1 | 1.0500 | 240 |
| Example 2 | 1.0450 | 235 |
| Example 3 | 1.0400 | 230 |
| Example 4 | 1.0350 | 225 |
| Example 5 | 1.0300 | 220 |
| Example 6 | 1.0250 | 215 |
| Example 7 | 1.0200 | 210 |
| Comparative Example 1 | 1.0600 | 250 |
| Comparative Example 2 | 1.0550 | 245 |
| Comparative Example 3 | 1.0150 | 205 |
| Comparative Example 4 | 1.0100 | 200 |
| Comparative Example 5 | 1.0050 | 195 |
| Comparative Example 6 | 1.0000 | 190 |

### Evaluation 1: TEM Analysis

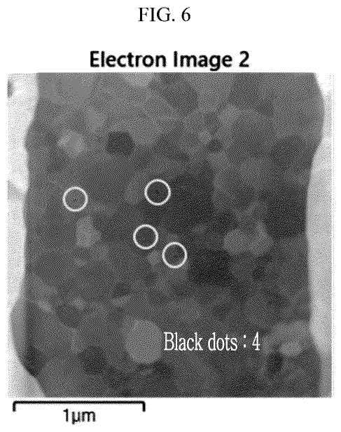

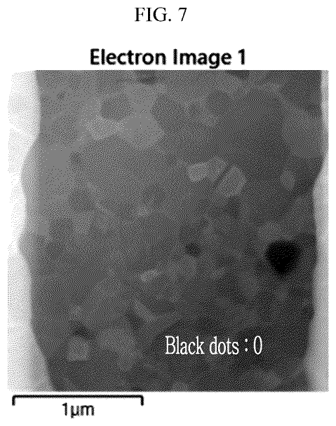

TEM (transmission electron microscope) analysis was performed on the multilayer ceramic capacitors manufactured in Examples 1 to 7 and Comparative Examples 1 to 6, and the results are shown in Table 2 and FIGS. 6 and 7.

Specifically, the cross-sectional samples were obtained such that the active region where the dielectric layer and the internal electrode layer intersect may be observed, as the multilayer ceramic capacitors manufactured in Examples 1 to 7 and Comparative Examples 1 to 6 were placed into an epoxy mixture liquid and cured, the W-axis and T-axis direction surface (WT surface) of the capacitor bodies were polished to a depth of ½ in the L-axis direction, and then they were fixed and maintained in a vacuum atmosphere chamber. Next, the active region of the cross-sectional sample can be measured using a scanning electron microscope (SEM) so that at least one layer of the dielectric layer was visible. TEM was measured under conditions of an acceleration voltage of 200 kV using an Xe-FIB (focused ion beam) in an area of about 2.5 μm×2.5 μm in which at least one dielectric layer was visible in the active region. The number of black dots per 1 μm×1 μm cross-section within the dielectric layer was confirmed in the TEM image of the measured cross-sectional sample.

TABLE 2

| | The number of black dots |
|---|---|
| | per 1 μm × 1 μm cross-section |
| Example 1 | 4 |
| Example 2 | 6 |
| Example 3 | 8 |
| Example 4 | 10 |
| Example 5 | 12 |
| Example 6 | 14 |
| Example 7 | 16 |
| Comparative Example 1 | 0 |
| Comparative Example 2 | 2 |
| Comparative Example 3 | 18 |
| Comparative Example 4 | 20 |
| Comparative Example 5 | 22 |
| Comparative Example 6 | 24 |

FIG. 6 is a TEM (transmission electron microscope) image of a dielectric layer according to Example 1, and FIG. 7 is a TEM (transmission electron microscope) image of a dielectric layer according to Comparative Example 1.

Referring to FIGS. 6 and 7, in the case of Example 1, the number of black dots per 1 μm×1 μm cross-sectional area within the dielectric layer is 4 as in Table 2, whereas in the case of Comparative Example 1, no black dots exist.

### Evaluation 2: TEM-EDS Analysis

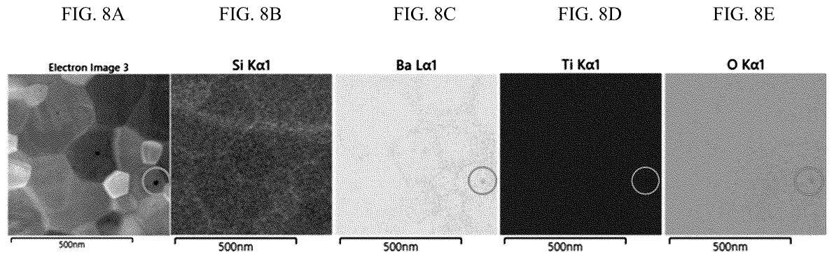

TEM-EDS (transmission electron microscope-energy dispersive spectroscopy) analysis was performed on the multilayer ceramic capacitors manufactured in Examples 1 to 7 and Comparative Examples 1 to 6, and the results are shown in FIGS. 8A to 12B.

Specifically, by performing EDS (energy dispersive spectroscopy) analysis on the TEM image of the cross-sectional sample obtained in Evaluation 1, the components included in the black dots 20 within the dielectric layer 111 can be confirmed.

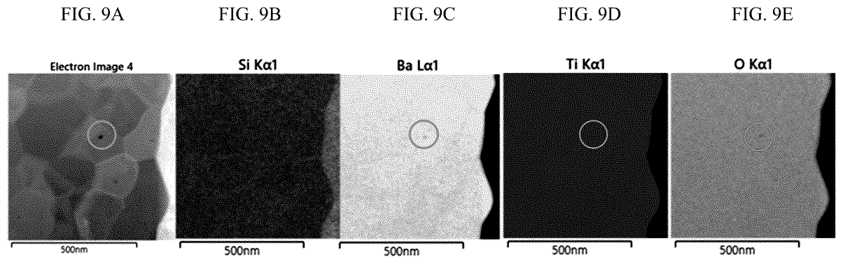

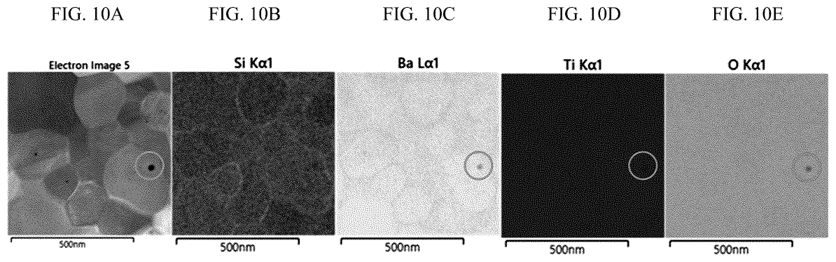

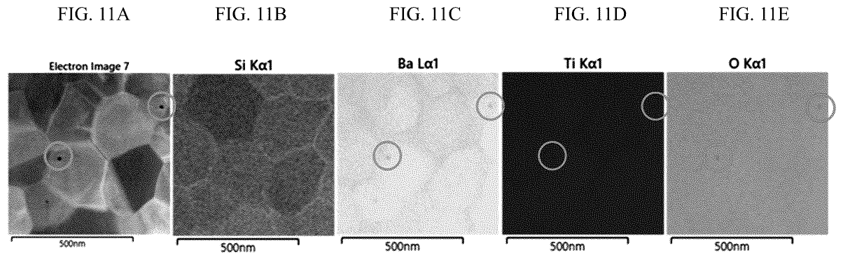

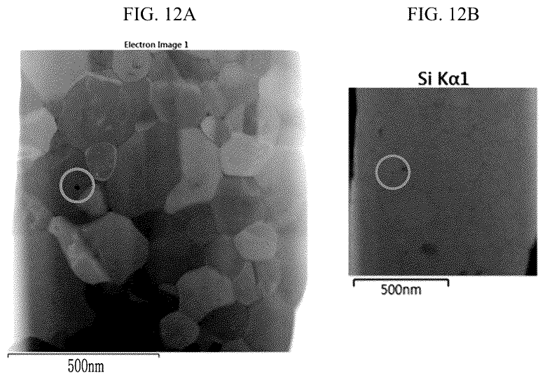

FIGS. 8A to 8E are TEM-EDS (Transmission Electron Microscope-Energy Dispersive Spectroscopy) analysis images of a dielectric layer according to Example 1, FIGS. 9A to 9E are TEM-EDS (Transmission Electron Microscope-Energy Dispersive Spectroscopy) analysis images of a dielectric layer according to Example 2, FIGS. 10A to 10E are TEM-EDS (Transmission Electron Microscope-Energy Dispersive Spectroscopy) analysis images of a dielectric layer according to Example 3, FIGS. 11A to 11E are TEM-EDS (Transmission Electron Microscope-Energy Dispersive Spectroscopy) analysis images of a dielectric layer according to Example 4, and FIGS. 12A to 12B are TEM-EDS (Transmission Electron Microscope-Energy Dispersive Spectroscopy) analysis images of a dielectric layer according to Comparative Example 1.

Referring to FIGS. 8A to 12B, in Examples 1 to 4, black dots included in dielectric grains in each of the dielectric layers were confirmed to include Si elements but no Ba, Ti, and O elements. On the contrary, in Comparative Example 1, dots shown in FIGS. 12A to 12B looked similar to the black dots but included no Si elements and thus were assumed to differ from the black dots according to an embodiment.

### Evaluation 3: Withstand Voltage Characteristics

The multilayer ceramic capacitors according to Examples 1 to 7 and Comparative Examples 1 to 6 were measured with respect to breakdown voltage (BDV), and the results are shown in Table 3.

5 The breakdown voltage (BDV) was measured by preparing each of the multilayer ceramic capacitors of Examples 1 to 7 and Comparative Examples 1 to 6 by 50, applying a voltage thereto in a sweep manner from 0 V to 1100 V by 1.00000 V with a Keithley measuring device Model No. 2410 to obtain a voltage at a moment when a current became 20 mA, and the results are shown in Table 3. The breakdown voltage (BDV) was measured in a silicone oil bath.

In Table 3, minimum and average values of the measured BDV are provided.

TABLE 3

| | The number of black | BDV | BDV |
|---|---|---|---|
| | dots per 1 μm × 1 μm | average | minimum |
| | cross-section | value (V) | value (V) |
| Example 1 | 4 | 127 | 110 |
| Example 2 | 6 | 130 | 109 |
| Example 3 | 8 | 125 | 111 |
| Example 4 | 10 | 123 | 113 |
| Example 5 | 12 | 131 | 114 |
| Example 6 | 14 | 128 | 109 |
| Example 7 | 16 | 127 | 111 |
| Comparative Example 1 | 0 | 97 | 69 |
| Comparative Example 2 | 2 | 99 | 76 |
| Comparative Example 3 | 18 | 125 | 112 |
| Comparative Example 4 | 20 | 130 | 108 |
| Comparative Example 5 | 22 | 124 | 111 |
| Comparative Example 6 | 24 | 124 | 109 |

Referring to Table 3, Examples 1 to 7 having 4 to 16 black dots per 1 μm×1 μm cross-sectional area in a dielectric layer according to an embodiment, compared with Comparative Examples 1 and 2, exhibited a high insulation breakdown voltage and thus excellent withstand voltage characteristics. On the other hand, Comparative Examples 3 to 6 had excellent withstand voltage characteristics but as shown in Evaluation 4 to be described later, exhibited deteriorated high-temperature stress reliability and moisture resistance reliability.

### Evaluation 4: Reliability

The multilayer ceramic capacitors according to Examples 1 to 7 and Comparative Examples 1 to 6 were measured with respect to high-temperature stress reliability (HALT) and moisture resistance reliability, and the results are shown in Table 4.

Specifically, each of the multilayer ceramic capacitors according to Examples 1 to 7 and Comparative Examples 1 to 6 was prepared by 40 and mounted on a measurement substrate, wherein the high-temperature stress reliability (HALT) was measured by using ESPEC (PV-222, HALT) equipment under the condition of 150° C., 100 hours, and 100 V, and the moisture resistance reliability was measured by using ESPEC (PR-3J, 8585) equipment under the condition of 85° C., relative humidity (R.H.) of 85%, 32 V, and 24 hours.

TABLE 4

| | The | High-temperature stress | | Moisture |
|---|---|---|---|---|
| | number of | reliability | | resistance |
| | black dots | Mean time | Mean time | reliability |
| | per 1 μm × | to first | between | Failure |
| | 1 μm cross- | failure | failures | time |
| | section | (h) | (h) | (h) |
| Example 1 | 4 | 63 | 114 | No short |
| Example 2 | 6 | 68 | 109 | No short |
| Example 3 | 8 | 64 | 112 | No short |
| Example 4 | 10 | 61 | 117 | No short |
| Example 5 | 12 | 70 | 108 | No short |
| Example 6 | 14 | 67 | 109 | No short |
| Example 7 | 16 | 60 | 111 | No short |
| Comparative | 0 | 51 | 107 | No short |
| Example 1 | | | | |
| Comparative | 2 | 41 | 105 | No short |
| Example 2 | | | | |
| Comparative | 18 | 21 | 55 | No short |
| Example 3 | | | | |
| Comparative | 20 | 23 | 49 | No short |
| Example 4 | | | | |
| Comparative | 22 | 17 | 48 | No short |
| Example 5 | | | | |
| Comparative | 24 | 13 | 35 | No short |
| Example 6 | | | | |

Referring to Table 4, Examples 1 to 7 having 4 to 16 black dots per 1 μm×1 μm cross-sectional area in a dielectric layer according to an embodiment, compared with Comparative Examples 1 to 6, exhibited excellent high-temperature stress reliability and moisture resistance reliability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including a dielectric layer and an internal electrode layer, and
an external electrode disposed on an outside of the capacitor body,
wherein the dielectric layer comprises a plurality of dielectric grains, and at least one of the plurality of dielectric grains comprises at least one black dot,
the dielectric layer includes 4 to 16 of the at least one black dot per 1 μm×1 μm cross-sectional area within the dielectric layer, and
the at least one black dot comprises Si element and is free of at least two elements selected from Ba, Ti, and O.

2. The multilayer ceramic capacitor of claim 1, wherein
a size of the at least one black dot measured on a straight line drawn along a major axis of the dielectric grains is from 5 nm to 40 nm.

3. The multilayer ceramic capacitor of claim 1, wherein
the dielectric layer further comprises a black dot peripheral region defined as a region extending (i) from the at least one black dot to a distance corresponding to 10% to 100% of a size of the at least one black dot, and (ii) in an outer direction of the at least one black dot.

4. The multilayer ceramic capacitor of claim 3, wherein
the black dot peripheral region has a shape surrounding the at least one black dot.

5. The multilayer ceramic capacitor of claim 3, wherein
the black dot peripheral region comprises a Si element, a Ba element, and a Ti element.

6. The multilayer ceramic capacitor of claim 5, wherein
the dielectric layer comprises a barium titanate-based main component including Ba and Ti, and a subcomponent including Si.

7. The multilayer ceramic capacitor of claim 6, wherein
the Si element included in the at least one black dot and the Si element included in the black dot peripheral region are at a molar ratio that is in a range of 1:8 to 8:1 based on 100 parts by mole of the barium titanate-based main component.

8. The multilayer ceramic capacitor of claim 6, wherein
the subcomponent further comprises one or more selected from Dy, Tb, Mn, V, Ba, Al, Ca, and Sn.

9. The multilayer ceramic capacitor of claim 8, wherein the subcomponent comprises Dy, Tb, Mn, V, Ba, Al, Ca, and Sn.

10. The multilayer ceramic capacitor of claim 1, wherein the at least one of the plurality of dielectric grains comprises one black dot.

11. The multilayer ceramic capacitor of claim 1, wherein the at least one black dot is free of Ba, Ti, and O.

12. A method of manufacturing a multilayer ceramic capacitor, comprising
mixing a barium titanate-based main component powder and a subcomponent powder to prepare a dielectric slurry;
manufacturing a dielectric green sheet using the dielectric slurry and forming a conductive paste layer on a surface of the dielectric green sheet;
manufacturing a dielectric green sheet stack by stacking a plurality of the dielectric green sheet on which the conductive paste layer is formed;
manufacturing a capacitor body including a dielectric layer and an internal electrode layer by firing the dielectric green sheet stack; and
forming an external electrode on a surface of the capacitor body,
wherein the dielectric layer includes a plurality of dielectric grains, and at least one of the plurality of dielectric grains comprises at least one black dot, the dielectric layer includes 4 to 16 black dots per 1 μm×1 μm cross-sectional area within the dielectric layer, and the black dot includes Si element and does not include at least two elements selected from Ba, Ti, and O.

13. The method of claim 12, wherein
the barium titanate-based main component powder is prepared by a hydrothermal synthesis method comprising
mixing a barium raw material and a titanium raw material to prepare a barium titanate seed; and
grain-growing the barium titanate seed.

14. The method of claim 13, wherein
the barium raw material and the titanium raw material are mixed so that a Ba/Ti molar ratio is 1.020 to 1.050.

15. The method of claim 13, wherein
the grain-growing is performed at a temperature of 208° C. to 242° C.

16. The method of claim 12, wherein
the subcomponent powder comprises a Si-containing compound.

17. The method of claim 16, wherein
the Si-containing compound is included in an amount of powder 0.5 parts by mole to 4 parts by mole based on 100 parts by mole of the barium titanate-based main component powder.

18. The method of claim 16, wherein
the subcomponent powder further comprises at least one selected from a Dy-containing compound, a Tb-containing compound, a Mn-containing compound, a V-containing compound, a Ba-containing compound, an Al-containing compound, a Ca-containing compound, and a Sn-containing compound.
